(19) United States
(12) Patent Application Publication
(10) Pub. No.: US 2015/0009825 A1
(43) Pub. Date: Jan. 8, 2015

(54) METHOD FOR OPERATING POLICY OF REDUCING NETWORK LOAD, SYSTEM AND RECORDING MEDIUM THEREOF

(71) Applicant: IDEAWARE INC., Seongnam-si, Gyeonggi-do (KR)

(72) Inventor: Yang Meong Cha, Seongnam-si (KR)

(73) Assignee: IDEAWARE INC., Seongnam-si, Gyeonggi-do (KR)

(21) Appl. No.: 14/347,584

(22) PCT Filed: Feb. 12, 2013
(86) PCT No.: PCT/KR2013/001059

§ 371 Date: Mar. 26, 2014

(30) Foreign Application Priority Data
Feb. 13, 2012 (KR) 10-2012-001443

(51) Int. Cl. H04W 28/08; H04L 29/12; H04L 12/803; H04W 74/06; H04L 12/813

(52) U.S. Cl. CPC H04W 28/08; H04W 74/06; H04L 47/20; H04L 47/125; H04L 61/2007
USPC 370/235

(57) ABSTRACT

The present invention relates to a method of operating policy information for reducing network load, a system thereof, and a recording medium thereof. The system of operating policy information for reducing network load, comprising: a reception unit for receiving information of a policy applicable target application and network usage pattern information of the policy applicable target application; a generation unit for generating network usage control policy information of the policy applicable target application by using the network usage pattern information of the policy applicable target application; and a process unit for processing so that the policy information for reducing network load, the policy information including the network usage control policy information of the policy applicable target application generated by the generation unit and the information of a policy applicable target application, is transmitted to an application for reducing network load included in an user's wireless terminal device.

### BACKGROUND OF THE INVENTION

1. Technical Field

The present invention relates to process of reduction wireless network load by generating network usage control policy information corresponding to network usage pattern information of each application included in a wireless terminal device and providing the generated network usage control policy information to the wireless terminal device.

2. Description of the Related Art

After smart phones are introduced to the public, using patterns of terminal devices by individual users are rapidly moving from voice-call-oriented use to data-communication-oriented use.

As mobile (wireless) data traffic indexes in FIG. 1 show, mobile traffic is expected to continuously increase up to 26 times for the next 10 to 15 years. In the year 2010, an individual user daily used around 15 MB of mobile data, which may reach 1 GB in the year 2020.

Such increase in mobile traffic directly affects profitability and service quality of mobile carriers, forcing them to install additional equipment, consequently reducing their profits. Service dissatisfactions of mobile network users are also increasing, because of slowed speed of data communication.

Accordingly, in order to reduce investment burden and to ensure service quality, the mobile carriers are facing a challenge to make more efficient use of network infra, and need alternatives which provide predictability and real-time controllability, overcoming the limitations of conventional technology.

Meanwhile, as FIG. 2 shows, mobile network congestions are mainly caused by unnecessary use of network by the applications installed in wireless terminal devices, numerous wireless terminal devices concentrated in a limited space (e.g. stadium, subway, etc.), and using patterns of users.

In conclusion, in order to solve out both the mobile carriers' enormous waste of cost and the individual users' service dissatisfaction, alternatives capable of controlling the network using patterns have become absolutely needed. But unfortunately, solutions for these problems have not been introduced so far.

The above-mentioned problems in conventional technology and the awareness on the challenge are not obviously known for the persons who skilled in the art of the present invention. Therefore, the present invention shall not be deemed to be obvious based on this awareness.

### SUMMARY OF THE INVENTION

An object of the present invention for solving the above-mentioned problems is providing a method, a system and a recording medium for receiving network usage pattern information of one or more policy applicable target applications included in the wireless terminal device, generating network usage control policy information of the policy applicable target application by using the received network usage pattern information, processing so that policy information for reducing network load is transmitted to an application for reducing network load included in the wireless terminal device, the policy information comprising the generated network usage control policy information of the policy applicable target application and information of the policy applicable target application, and eventually enabling the application for reducing network load included in the wireless terminal device to control an optimized usage of the network through the policy information directly at the wireless terminal device side. With this, the mobile carriers may be able to reduce the installation cost of additional equipment and improve the service quality. At the same time, the user's data communication environment may be also improved by resolving the network congestions, with reduced consumption of batteries. In addition, the application developers and mobile carriers may operate reasonable discussion channels for each other.

Technical tasks to achieve in the present invention are not limited to the above-mentioned technical tasks. Other technical tasks which are not mentioned may be clearly understandable for those who skilled in the art of the present invention from the following description.

According to an aspect of the present invention, by operating the network usage control policy information corresponding to the network usage pattern information of each application included in the wireless terminal device, it may be possible to block or adjust unnecessary executions of applications which may cause network load by the policy. With this, it may also be possible to use the network optimally at the wireless terminal device side.

According to another aspect of the present invention, by optimizing network usage, the mobile carriers may be able to minimalize the installation cost of additional equipment.

According to another aspect of the present invention, by optimizing network usage, it may be possible to minimalize wireless terminal device user's dissatisfaction caused by data communication delay, etc. Additionally, battery consumption of the wireless terminal device may be reduced dramatically.

According to another aspect of the present invention, through network usage pattern information for each of the applications, application developers and mobile carriers may discuss easily in order to reduce network load.

### BRIEF DESCRIPTION OF THE DRAWINGS

FIG. 1 shows a view illustrating a mobile (wireless) data traffic indexes.

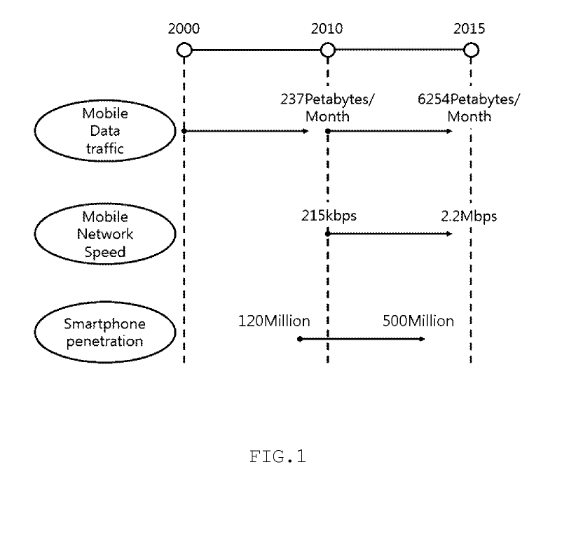

FIG. 2 shows a view illustrating main factors causing network congestions of the conventional technology.

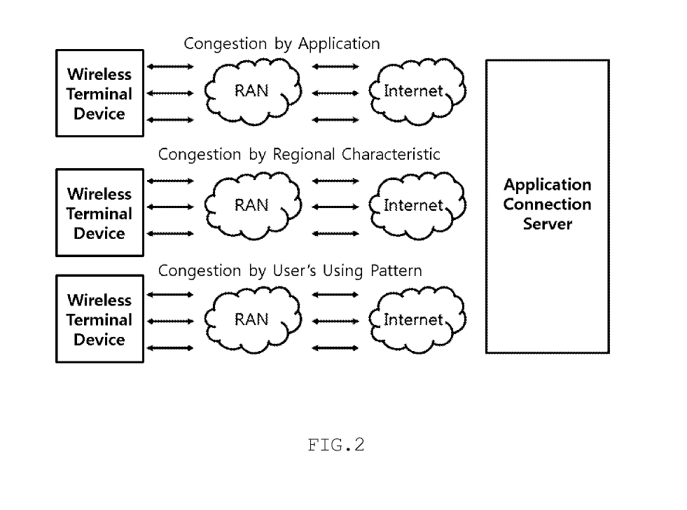

FIG. 3 shows a view illustrating communication network connection according to an embodiment of the present invention.

FIG. 4 shows a view illustrating detailed structure of an policy server according to an embodiment of the present invention.

FIG. 5 shows a view illustrating examples of operating policy information by the policy server according to an embodiment of the present invention.

FIG. 6 shows a view illustrating an effect of controlling network usage through the policy information according to an embodiment of the present invention.

FIG. 7 shows a flow chart illustrating a process of operating a policy by the policy server according to an embodiment of the present invention.

### DESCRIPTION OF THE PREFERRED EMBODIMENTS

Hereinafter, referring to enclosed figures and descriptions, operation principles of preferred embodiments of the present invention will be described. However, figures illustrated and descriptions mentioned in the below are only for the preferred embodiments among various method of describing features of the present invention. Therefore, the present invention is not limited to the figures illustrated and descriptions mentioned in the below. Additionally, in case of determining that a detailed description about known function or structure relating to the present invention may evade the main point of the present invention, the detailed description may be omitted. Also, terms to be mentioned in the following are defined in consideration of functions in the present invention, which may be vary according to the intention of a user or an operator, practical customs, etc. Therefore, the definition of the terms shall be made based on the overall contents of the present invention.

In conclusion, the technical spirit of the present invention shall be decided by claims. The following embodiments are merely a means for describing progressive spirit of the present invention to persons who skilled in the art of the present invention.

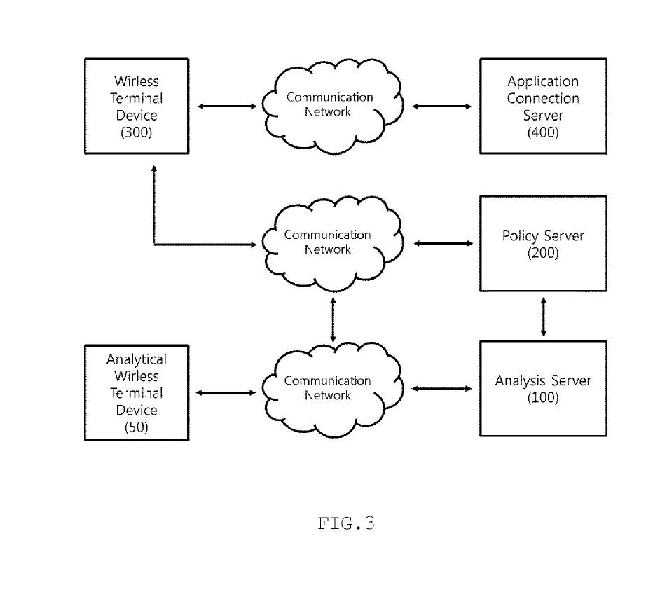

FIG. 3 shows a view illustrating a communication network or network connection according to an embodiment of the present invention.

More particularly, FIG. 3 is illustrating a structure of a system of operating policy information for reducing network load, the system including a policy server 200. The system, connected with an analysis server 100 and a user's wireless terminal device 300 over communication network, after receiving information of a policy applicable target application and network usage pattern information of the policy applicable target application from the analysis server 100, generates network usage control policy information of the policy applicable target application by using network usage pattern information of the policy applicable target application, and processes so that the generated network usage control policy information is transmitted to an application for reducing network load included in the wireless terminal device.

The system of operating policy information for reducing network load according to an embodiment of the present invention may configure various structures according to the implementation methods and the network connection methods over the communication network.

The policy sever 200, a core component of the system of operating policy information for reducing network load according to the present invention, performs a role of generating the network usage control policy information of the policy applicable target application by using the network usage pattern information of each application. And, the policy sever 200 performs a role of processing so that the policy information for reducing network load is transmitted to the application for reducing network load included in the user's wireless terminal device 300, the policy information comprising the generated network usage control policy information of the policy applicable target application and information of the policy applicable target application.

The analysis sever 100 according to the present invention performs a role of obtaining the network usage pattern information of the analysis target application included in the analytical wireless terminal server 50 and/or a user's wireless terminal device 300. And, the analysis sever 100 performs a role of transmitting the obtained network usage pattern information of the analysis target application the policy server 200 over the communication network so that the policy server 200 generates the network usage control policy information of each application for reducing network load by using the network usage pattern information of each application.

According to the present invention, the analysis server 100 may be included in the policy server 200, or configured to an individual server separated from the policy server 200. The analytical wireless terminal server 50 and/or a user's wireless terminal device 300 according to the present invention perform a role of installing a detecting application provided by the analysis server 100, and then transmitting the network usage information of one or more analysis target applications included in the wireless terminal device to the analysis server 100 the using detection application.

Also, the user's wireless terminal device 300 according to the present invention may receive policy information—the policy information including at least one of policy applicable target application information and network usage control policy information for each of the policy applicable target applications—for reducing network load from the policy server 200, and store the policy information into a storage section. The user's wireless terminal device 300 then may check the policy applicable target application information included in the policy information stored in the storage section, and in a result of the checking, in case the policy applicable target application exists in the wireless terminal device 100, may perform a role of controlling network usage environment for the application by applying the network usage control policy information pre-stored in the storage section for the application to the application.

According to the present invention, the analytical wireless terminal server 50 and/or a user's wireless terminal device 300 may include all kinds of terminal devices which enable data communication through network, such as smart phones, mobile phones, tablet PCs, telematics, etc.

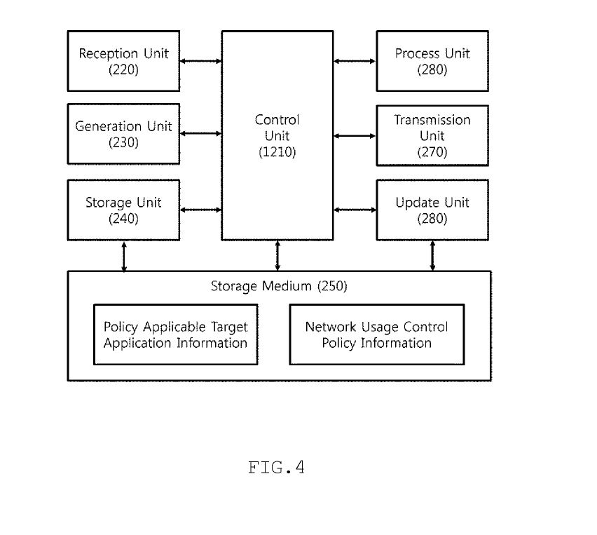

FIG. 4 shows a view illustrating detailed structure of the policy server 200 according to an embodiment of the present invention.

More particularly, FIG. 4 shows a detailed structure of the policy server 200 in the system of operating policy information for reducing network load as shown in FIG. 3. Each component of the structure is merely for describing embodiments of the present invention. The technical feature of the present invention is not limited to the embodiments shown in FIG. 4.

Referring to FIG. 4, the policy server 200 according to an embodiment of the present invention may include a reception unit 220, a generation unit 230, a storage unit 240, a storage medium 250, a process unit 260, a transmission unit 270, update unit 280, and a control unit 210 which may control each of the components described above.

Here, though the policy server 200 is shown as a single server in the drawing for a description of an example, may be composed of one or more separated servers for the each mean or component.

Referring to FIG. 4, the reception unit 220 receives the network usage pattern information of the policy applicable target application through the analysis server 100.

The generation unit 230 according to an embodiment of the present invention generates the network usage control policy information of the policy applicable target application by using the network usage pattern information of the policy applicable target application received by the reception unit 220.

According to the present invention, the generation unit 230 checks the network usage pattern information of the policy applicable target application, and then generates policy information.

The network usage pattern information may include at least one of:

information on number of connections to a certain IP or Port or URL per hour by the analysis target application,

information on number of pollings requesting data to a certain IP or Port or URL by the analysis target application,

information on number of pushes transmitting data to a certain IP or Port or URL or ID by the analysis target application,

information on size or capacity of data transmitted to a certain IP or Port or URL or ID by the analysis target application,

information on request and reception of user unauthorized target data including commercial data by the analysis target application,

in case a limit allocated to the wireless terminal device is exceeded by the analysis target application, information on connection of data communication, and

in case a communication network overload is set in a region where the wireless terminal device is located, information on connection of data communication by the analysis target application.

And, the network usage control policy information includes at least one of:

policy information for adjusting number of connections to a certain IP or Port or URL per hour;

policy information for adjusting number of pollings requesting data to a certain IP or Port or URL;

policy information for adjusting number of pushes transmitting data to a certain IP or Port or URL or ID;

policy information for adjusting size or capacity of data transmitted to a certain IP or Port or URL or ID;

policy information for blocking request and reception of user unauthorized target data including commercial data;

policy information, in case a limit allocated to the wireless terminal unit is exceeded, for blocking connection of data communication; and

policy information, in case a communication network overload is set in a region where the wireless terminal device is located, for blocking connection of data communication.

An embodiment of the network usage control policy information generated by the generation unit 230 according to the present invention is as in the following.

<?xml version ″1.0″ encoding=″UTF-8″?>
<policy>
<description> Rules for block app </description>
<rule>
<rule_id> T_2012_B_02_103030_P2 </rule_id>
<rule_act> B_03_P_01 </rule act>
<app_id> T_2012_A_08_2089_K2_09_3092 </app_id>
<target_ip> 192.168.0.255 </target_ip>
<port> 80 </port>
<refresh> 30 sec </refresh>
</rule>
<sign>e5c6e5ccec361baebcf79859e49c5526</sign>
</policy>

In the above example of policy, “<rule_id> T_{—}2012_B_{—}02_{—}103030_P2 </rule_id>” defines the policy value, which indicates that the policy is application network blocking policy (B02)in the year 2012, and the policy administrator's authority is 103030, and the priority for applying the policy is P2 level.

Here, “<rule_id> T_{—}2012_B_{—}02_{—}103030_P2 </rule_id>” may be replaced by “<rule_id> T_{—}2012_P_{—}02_{—}103030_P2 </rule_id>” used for application network polling policy (P02) in the year 2012, or may be used for application network loopback policy (L05) in the year 2012, or may be replaced by “<rule_id> T_{—}2012_L_{—}05_{—}103030_P3 </rule_id>” which indicates that the policy administrator's authority is 103030 and the priority for applying the policy is P3 level.

In addition, “<rule_act> B_{—}03_P_{—}01 </rule_act>” is indicating that the performing method for applying the policy is “apply immediately”. And, “<app_id> T_{—}2012_A_{—}08_2089_K2_09_{—}3092 </app_id>” means that the policy applicable application ID is from “A_{—}08_{—}2089_K2” to “09_{—}3092” and a mask value of the policy applicable application is K2.

And, “<sign>e5c6e5ccec361baebcf79859e49c5526</sign>” is a value for integrity verification of the policy information in order to check if the policy document is tampered while coming through the network. “<target_ip> 192.168.0.255 </target_ip>”, and “<port>80 </port>” indicate that the target IP address for blocking (functions such as loopback) is 192.168.0.255, and the target port is 80, respectively.

In addition, “<refresh> 30 sec </refresh>” means that refresh timeout is set to 30 sec. In this case, proxy/cache server will be used for the corresponding packet, and at this time, it means that the request packet transmitted from the wireless terminal device 100 to the network will be forwarded to the proxy/cache server every 30 seconds.

In this case, for transmitting the packet from user's wireless terminal device 100, methods such as forwarding, registering the corresponding bypass information in DNS server, or dynamically/statically changing a routing table for the certain IP address may be used. Unconditional forwarding (bypass) method using the wireless terminal device 100 of user may be used for blacklisting policy for chronic malignant service/packet.

The above described policy information is merely an embodiment, may be various according to characteristics or type of the policy.

The storage unit 240 according to an embodiment of the present invention stores the network usage control policy information of the policy applicable target application generated by the generation unit 230, in connection with the policy applicable target application information, in the storage medium 250.

According to the present invention, the storage unit 240 updates the network usage control policy information of the policy applicable target application stored in the storage medium 250 whenever the network usage control policy information of the policy applicable target application is updated, and stores the updated network usage control policy information in the storage medium 250.

The storage medium 250 according to the present invention performs a role of storing the network usage control policy information of the one or more policy applicable target applications stored by the storage unit 240 in connection with the policy applicable target application information.

According to the present invention, the storage medium 250 may be included in the policy server 200 or a separate server over the communication network.

Also, the storage medium 250 may further store the network usage pattern information of the policy applicable target application received by the reception unit 220.

The process unit 260 according to the present invention performs a role of processing so that the policy information for reducing network load is transmitted to the application for reducing network load included in the user's wireless terminal device 300, the policy information comprising the network usage control policy information of the policy applicable target application and the policy applicable target application information stored in the storage medium 250.

The transmission unit 270 according to the present invention performs a role of processing so that the policy information is transmitted to the application for reducing network load included in the user's wireless terminal device 300, interlocking with the process unit 260.

The update unit 280 according to the present invention performs a role of, if the network usage control policy information of the policy applicable target application is changed, processing an upgrade for the changed network usage control policy information of the policy applicable target application, linked with the application for reducing network load.

According to the present invention, a whole or a part of the functions of each component included in the policy server 200 may be implemented in a program or program set.

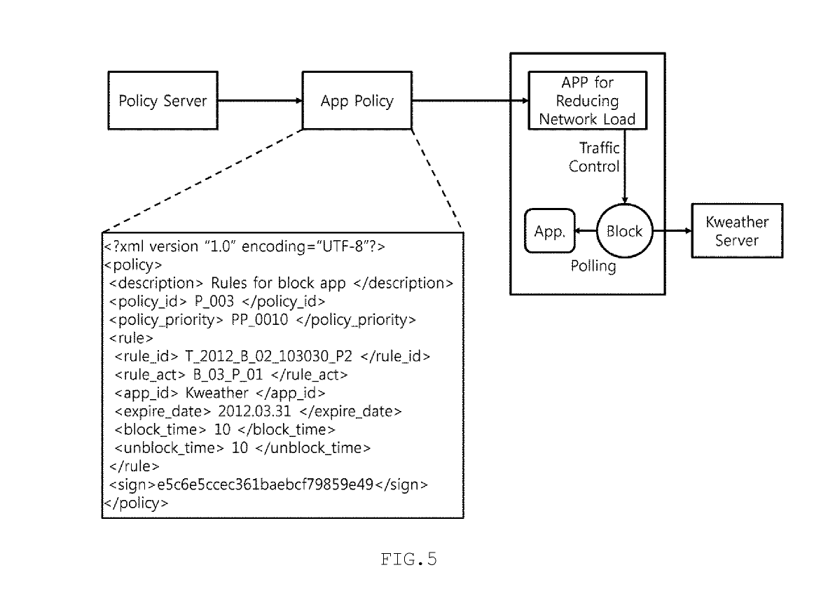

FIG. 5 shows a view illustrating examples of operating the policy information by the policy server 200 according to an embodiment of the present invention.

Referring to FIG. 5, unnecessary data polling of an application for providing weather information may be blocked by generating the network usage control policy information of the application for providing weather information included in the wireless terminal device and transmitting the generated network usage control policy information to the application for reducing network load included in the wireless terminal device.

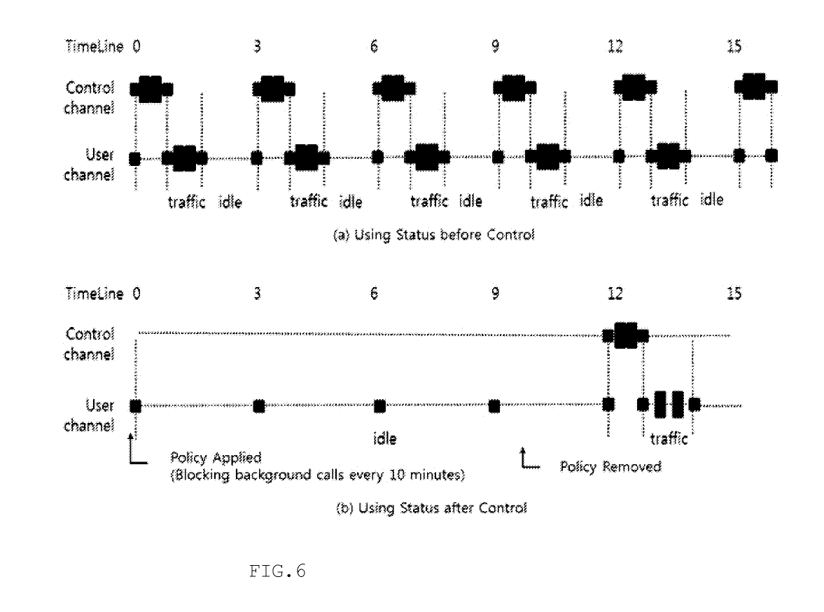

FIG. 6 shows a view illustrating an effect of controlling network usage using the policy information according to an embodiment of the present invention.

Referring to FIG. 6, in response to the network usage control using the network usage control policy information (policy for blocking background call admission every 10 minutes) by the application for reducing network load included in the wireless terminal device, the effect of traffic reduction in the wireless terminal device before and after network usage environment control by applying the policy is shown.

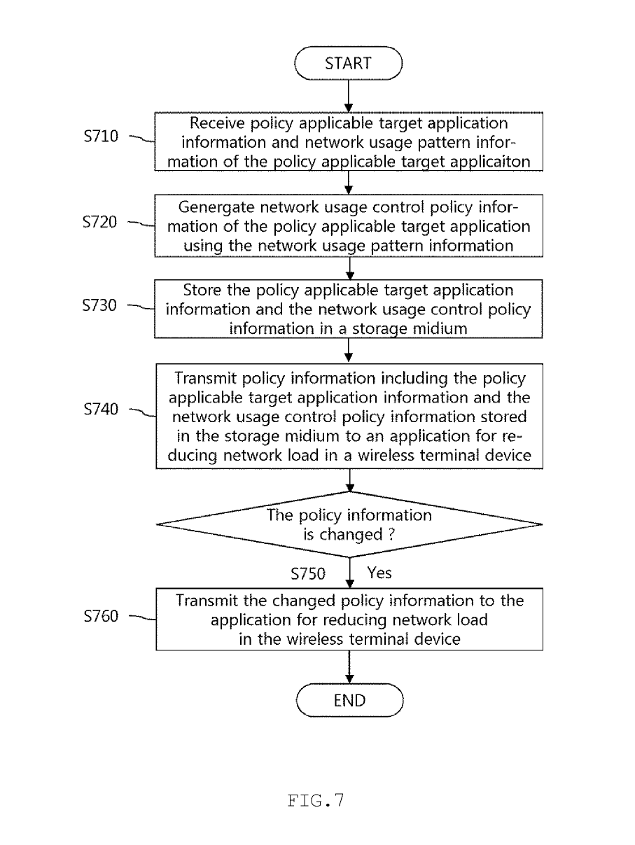

FIG. 7 shows a view illustrating a process for operating the policy by the policy server 200 according to an embodiment of the present invention.

At first, the policy server 200 receives the network usage pattern information of the policy applicable target application through the reception unit 220 (S710).

Afterwards, the policy server 200 generates the network usage control policy information of the policy applicable target application by using the network usage pattern information of the policy applicable target application through the generation unit 230 (S720).

According to the present invention, the generation unit 230 checks the network usage pattern information of the policy applicable target application, and then generates policy information.

The network usage pattern information may include at least one of:

information on number of connections to a certain IP or Port or URL per hour by the analysis target application,

information on number of pollings requesting data to a certain IP or Port or URL by the analysis target application,

information on number of pushes transmitting data to a certain IP or Port or URL or ID by the analysis target application,

information on size or capacity of data transmitted to a certain IP or Port or URL or ID by the analysis target application,

information on request and reception of user unauthorized target data including commercial data by the analysis target application,

in case a limit allocated to the wireless terminal device is exceeded by the analysis target application, information on connection of data communication, and

in case a communication network overload is set in a region where the wireless terminal device is located, information on connection of data communication by the analysis target application.

And, the network usage control policy information includes at least one of:

policy information for adjusting number of connections to a certain IP or Port or URL per hour;

policy information for adjusting number of pollings requesting data to a certain IP or Port or URL;

policy information for adjusting number of pushes transmitting data to a certain IP or Port or URL or ID;

policy information for adjusting size or capacity of data transmitted to a certain IP or Port or URL or ID;

policy information for blocking request and reception of user unauthorized target data including commercial data;

policy information, in case a limit allocated to the wireless terminal unit is exceeded, for blocking connection of data communication; and

policy information, in case a communication network overload is set in a region where the wireless terminal device is located, for blocking connection of data communication.

Afterwards, the policy server 200 stores the network usage control policy information of the policy applicable target application generated by the generation unit 230, in connection with the policy applicable target application information, in the storage medium 250 through the storage unit 240 (S730).

Afterwards, the policy server 200 processes so that the policy information for reducing network load is transmitted to the application for reducing network load included in the user's wireless terminal device 300, the policy information comprising the network usage control policy information of the policy applicable target application and the policy applicable target application information stored in the storage medium 250, through the process unit 260 and the transmission unit 270 (S740).

Afterwards, in case the network usage control policy information of the policy applicable target application is changed (S750), the policy server 200 upgrades one or more changed items of the network usage control policy information of the policy applicable target application pre-stored in the storage medium 250 through the update unit 280, and then processes so that the changed policy information is transmitted to the application for reducing network load through the process unit 260 and transmission unit 270 (S760).

In addition, the above-described present invention may be implemented as a program executable in a computer and may be stored in a computer-readable recording medium; examples of the computer-readable recording medium may be ROM, RAM, CD-ROM, Magnetic Tape, Floppy Disk, Optical Data Storage, etc., including carrier wave (e.g., transmission through internet).

The computer-readable recording medium may be distributed to a computer systems connected in a network, so that the computer-readable code may be stored and executed in a distributed mode. Also, functional program, code and code segments for implementing the controlling method may be inferred easily by programmers who skilled in the art of the present invention.

In the above, preferred embodiments of the present invention have been described. However, these embodiments are merely examples and do not limit the present invention, so that persons who skilled in the art of the present invention may easily transform and modify within the limit of the technical spirit of the present invention. For example, each of the components shown in detail in the embodiments of the present invention may be implemented in transformation. In addition, the differences relating these transformations and modifications shall be regarded to be included in the scope of the present invention as defined in the attached claims of the present invention.

1-10. (canceled)

11. A system of operating policy information for reducing network load, the system being connected to a wireless terminal device using a communication network, comprising:
a reception unit for receiving network usage pattern information of a policy applicable target application that a policy for reducing network load is applied to;
a generation unit for generating network usage control policy information of the policy applicable target application by using the received network usage pattern information; and
a transmission unit for transmitting policy information to the wireless terminal device, wherein the policy information includes the generated network usage control policy information and information of the policy applicable target application.

12. The system of operating policy information for reducing network load according to claim 11, wherein the policy information transmitted to the wireless terminal device is provided to an application for reducing network load, the application for reducing network load being included in the wireless terminal device.

13. The system of operating policy information for reducing network load according to claim 12, further comprising:
a update unit for upgrading the network usage control policy information provided to the application for reducing network load in case the network usage control policy information is changed.

14. The system of operating policy information for reducing network load according to claim 11, further comprising:
a storage unit for storing the generated network usage control policy information, in connection with the policy applicable target application information, in a storage medium.

15. The system of operating policy information for reducing network load according to claim 11, wherein the network usage pattern information includes information of at least one of number of connections per hour, number of pollings requesting data, number of pushes transmitting data and size or capacity of data transmitted to a certain IP or URL by the policy applicable target application.

16. The system of operating policy information for reducing network load according to claim 11, wherein the network usage pattern information includes information of whether the policy applicable target application requests or receives unauthorized data including commercial data.

17. The system of operating policy information for reducing network load according to claim 11, wherein the network usage pattern information includes information of whether the policy applicable target application connects a data communication in case a data communication limit allocated to the wireless terminal device is exceeded or a communication network overload occurs in a region where the wireless terminal device is located.

18. The system of operating policy information for reducing network load according to claim 11, wherein the policy information is information for controlling periodic access or data communication by an application in background.

19. The system of operating policy information for reducing network load according to claim 18, wherein the policy information is information for controlling keep-alive or polling signals periodically transmitted by the application in background.

20. The system of operating policy information for reducing network load according to claim 11, wherein the network usage control policy information includes information for adjusting at least one of number of connections, number of pollings requesting data, number of pushes transmitting data and size or capacity of data transmitted to a certain IP or URL.

21. The system of operating policy information for reducing network load according to claim 11, wherein the network usage control policy information includes information for blocking request and reception of unauthorized data including commercial data.

22. The system of operating policy information for reducing network load according to claim 11, wherein the network usage control policy information includes information for blocking connection of data communication in case a data communication limit allocated to the wireless terminal device is exceeded or a communication network overload occurs in a region where the wireless terminal device is located.

23. The system of operating policy information for reducing network load according to claim 11, wherein the network usage control policy information includes information of a type or an application time for the policy information.

24. A method of operating policy information for reducing network load in a system connected to a wireless terminal device using a communication network, comprising:
receiving network usage pattern information of a policy applicable target application that a policy for reducing network load is applied to;
generating network usage control policy information of the policy applicable target application by using the received network usage pattern information;
storing the generated network usage control policy information, in connection with the policy applicable target application information, in a storage medium; and
transmitting policy information to the wireless terminal device, wherein the policy information includes the generated network usage control policy information and information of the policy applicable target application.

25. The method of operating policy information for reducing network load according to claim 24, further comprising:
upgrading the network usage control policy information provided to an application for reducing network load in case the network usage control policy information is changed, the application for reducing network load being included in the wireless terminal device.

26. The method of operating policy information for reducing network load according to claim 24, wherein the network usage pattern information includes information of at least one of number of connections per hour, number of pollings requesting data, number of pushes transmitting data and size or capacity of data transmitted to a certain IP or URL by the policy applicable target application.

27. The method of operating policy information for reducing network load according to claim 24, wherein the network usage control policy information includes information for adjusting at least one of number of connections, number of pollings requesting data, number of pushes transmitting data and size or capacity of data transmitted to a certain IP or URL.

28. The method of operating policy information for reducing network load according to claim 24, wherein the network usage control policy information includes information for blocking request and reception of unauthorized data including commercial data.

29. The method of operating policy information for reducing network load according to claim 24, wherein the network usage control policy information includes information for blocking connection of data communication in case a data communication limit allocated to the wireless terminal device is exceeded or a communication network overload occurs in a region where the wireless terminal device is located.

30. A computer-readable recording medium for recording programs to execute the method of claim 24.
